(19) United States
(12) Patent Application Publication
(10) Pub. No.: US 2025/0315697 A1
(43) Pub. Date: Oct. 9, 2025

(54) System and Method for Explaining Models

(71) Applicant: Microsoft Technology Licensing, LLC, Redmond, WA (US)

(72) Inventors: Hadas Bitran, Ramat Hasharon (IL); Aaron Toby Bornstein, Zikhron Yaakov (IL); Tal Baumel, Tel-Aviv (IL); Ksenya Kveler, Nesher (IL); Ran Efrati, Tel-Aviv (IL)

(21) Appl. No.: 18/744,360

(22) Filed: Jun. 14, 2024

Related U.S. Application Data
(60) Provisional application No. 63/574,994, filed on Apr. 5, 2024.

(51) Int. Cl. G06N 5/04

(52) U.S. Cl. CPC G06N 5/04

(57) ABSTRACT

A computer-implemented method, computer program product and computing system for: enabling a generative AI system to effectuate an analysis protocol; defining a visual representation of the analysis protocol; associating various portions of the analysis protocol with various portions of the visual representation; enabling a user to utilize the generative AI system during an interactive session concerning the analysis protocol; and identifying an associated portion of the visual representation based, at least in part, upon a portion of the analysis protocol that is the current topic of the interactive session.

### RELATED APPLICATION(S)

This application claims the benefit of U.S. Provisional Application No. 63/574,994, filed on 5 Apr. 2024, the entire contents of which are incorporated herein by reference.

### TECHNICAL FIELD

This disclosure relates to generative AI systems and, more particularly, to systems for explaining generative AI systems.

### BACKGROUND

When a generative AI system executes an analysis protocol, users may find it challenging to ascertain their progress through the protocol due to various factors. Firstly, the lack of transparency inherent in many AI models can obscure users' understanding of the model's internal processes and decision-making mechanisms. Consequently, users may struggle to determine how far along the model is in executing the protocol or which specific steps it has completed. Moreover, analysis protocols themselves can be complex, involving multiple steps, parameters, and decision points. Generative AI systems may navigate these protocols in ways that are not immediately intuitive to users, further adding to the confusion about progress.

Additionally, the speed at which a generative AI system executes an analysis protocol can vary due to factors like data complexity, computational resources, and algorithmic intricacies. Users may misinterpret these variations in execution time as inconsistencies in progress, exacerbating their confusion. Furthermore, generative AI systems may provide limited or ambiguous feedback regarding progress, leaving users without clear indicators or checkpoints along the way. This lack of feedback can contribute to uncertainty about where users stand in the execution of the protocol.

### BRIEF DESCRIPTION OF THE DRAWINGS

FIG. 1 is a diagrammatic view of a model explanation process in accordance with various embodiments of the present disclosure;

FIG. 2 is a flow chart of one implementation of the model explanation process of FIG. 1 in accordance with various embodiments of the present disclosure; and

FIG. 3 is a diagrammatic view of a computer system and the model explanation process of FIG. 1 coupled to a distributed computing network in accordance with various embodiments of the present disclosure.

Like reference symbols in the various drawings indicate like elements.

### DETAILED DESCRIPTION OF THE PREFERRED EMBODIMENTS

As will be discussed in greater detail below, implementations of the present disclosure may associate various portions of an analysis protocol with various portions of a visual representation of the same, enabling a user to interact with a generative AI system during an interactive session concerning the analysis protocol and identify an associated portion of the visual representation based, at least in part, upon a portion of the analysis protocol that is the current topic of the interactive session. By identifying an associated portion of the visual representation, insight may be provided that explains the manner in which the analysis protocol operates.

The details of one or more implementations are set forth in the accompanying drawings and the description below. Other features and advantages will become apparent from the description, the drawings, and the claims.

### Model Explanation Process:

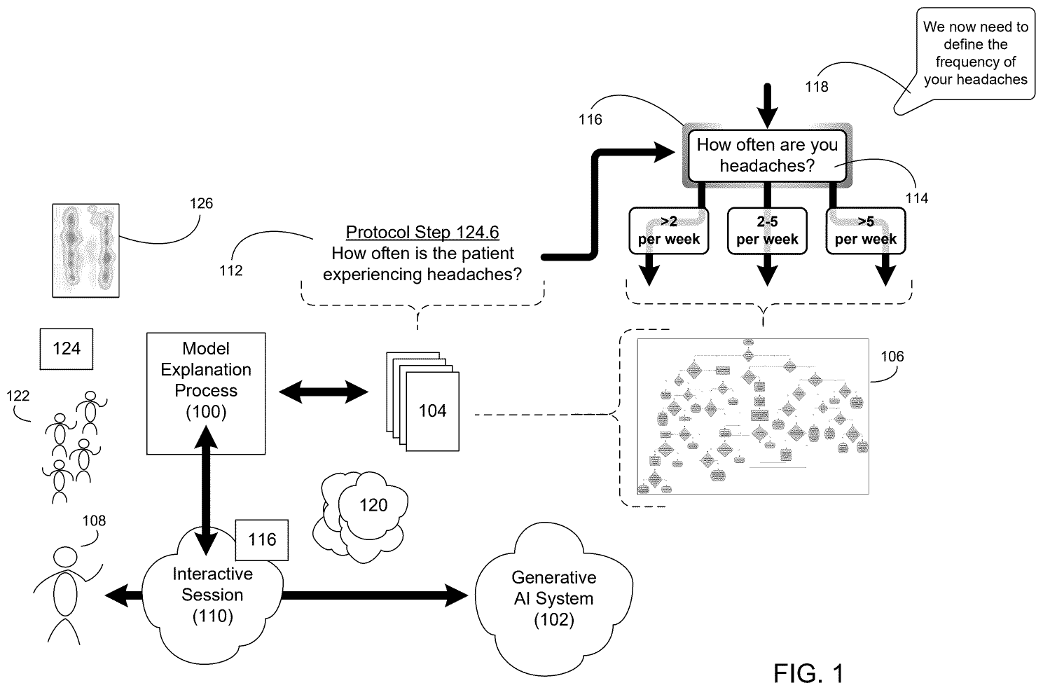

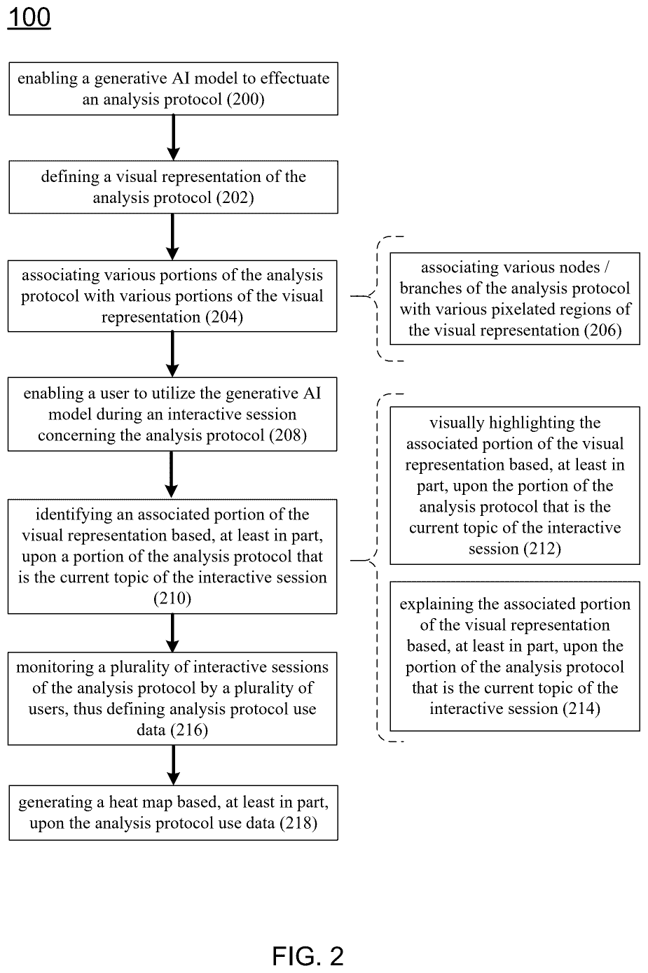

Referring to FIGS. 1-2, model explanation process 100 may enable 200 a generative AI system (e.g., generative AI system 102) to effectuate an analysis protocol (e.g., analysis protocol 104).

A generative AI system (e.g., generative AI system 102) is a type of artificial intelligence that is designed to generate or create content, often in the form of text, images, audio, or other media, based on patterns and knowledge learned from large datasets. These systems (e.g., generative AI system 102) use machine learning techniques, particularly deep learning, to understand and replicate the structures and features present in the data that they have been trained on. Such systems can then produce new content that is similar in style, format, or content to the data they've been exposed to.

Generative AI systems (e.g., generative AI system 102) have a wide range of applications, including:
Natural Language Generation (NLG): These systems can generate human-like text, including articles, stories, chatbot responses, and more. They are used in content generation, automated report writing, and even creative writing.
Image Generation: Generative models can create images, artwork, or even deepfake videos that resemble real images, often used in creative fields, image synthesis, and data augmentation for machine learning.
Music and Audio Generation: These systems can compose music or generate audio, including speech synthesis. They are used in music composition, voice assistants, and audio effects generation.
Data Augmentation: Generative AI can be used to create synthetic data to augment limited datasets for machine learning tasks, improving model performance.
Style Transfer: Generative AI can apply artistic styles to images or convert images from one artistic style to another, creating unique visual effects.

One of the most well-known types of generative AI systems is the Generative Adversarial Network (GAN), where two neural networks, a generator and a discriminator, work in tandem to create content and evaluate its authenticity. This adversarial training process helps the generator improve its content generation capabilities over time.

As used in this disclosure, an analysis protocol (e.g., analysis protocol 104), by its very nature, is a foundational element in various research and analytical endeavors. This detailed framework not only delineates the approach for conducting an analysis but also acts as a critical instrument for ensuring the integrity, consistency, and replicability of the research process. By explicitly stating the objectives of the analysis, the protocol (e.g., analysis protocol 104) provides a clear direction and purpose, aligning the research activities towards achieving specific outcomes. The methodology section of the protocol (e.g., analysis protocol 104) is its core, specifying the techniques and procedures for data collection, analysis, and interpretation.

In the healthcare space, analysis protocols (e.g., analysis protocol 104) are essential for ensuring that clinical practices, research, and diagnostic procedures are performed consistently, safely, and in accordance with the latest scientific evidence. These protocols (e.g., analysis protocol 104) cover a broad spectrum of activities, from patient care and treatment to laboratory testing and medical research, examples of which may include but are not limited to:
Clinical Practice Guidelines (CPGs): Clinical Practice Guidelines are systematically developed statements to assist practitioner and patient decisions about appropriate health care for specific clinical circumstances. For example, the American Heart Association (AHA) might publish guidelines for the management of patients with acute myocardial infarction. These guidelines would include protocols for diagnosis, treatment options, management of complications, and post-discharge care, all based on the latest evidence and expert consensus.
Laboratory Testing Protocols: Laboratory tests are fundamental in diagnosis and monitoring of diseases. A protocol for a blood glucose test, for instance, details the methods for collecting blood samples, the acceptable timing of collection (considering fasting requirements), handling and storage of samples, the testing procedure itself, and interpretation of results. This ensures accuracy in diagnosis and monitoring of conditions like diabetes.
Imaging Protocol in Radiology: Imaging protocols standardize the procedures for medical imaging, including the selection of imaging modalities (e.g., X-ray, MRI, CT scans), patient preparation, positioning, and parameters for image acquisition. A specific example could be an MRI protocol for detecting brain tumors, specifying the MRI sequences, slice thickness, and contrast agent use, ensuring that the images produced are of high quality and diagnostic value.
Surgical Safety Protocols: These protocols are designed to enhance patient safety and outcomes in surgical procedures. The World Health Organization's (WHO) Surgical Safety Checklist is a prime example, encompassing pre-operative, intra-operative, and post-operative phases to verify patient identity, surgical site and procedure, and ensure that all surgical equipment and safety measures are in place before the procedure begins.
Pharmacological Treatment Protocols: Treatment protocols define standardized medication regimens for various conditions, specifying drug choices, dosages, routes of administration, and duration of therapy. For example, protocols for antiretroviral therapy in HIV patients detail first-line and second-line drug regimens, monitoring schedules, and criteria for switching therapies in response to treatment failure or adverse effects.

These examples underline the critical role of analysis protocol (e.g., analysis protocol 104) in healthcare, guiding professionals through complex decision-making processes to ensure that care is based on the best available evidence, thereby optimizing patient outcomes.

Model explanation process 100 may define 202 a visual representation (e.g., visual representation 106) of the analysis protocol (e.g., analysis protocol 104).

The visual representation (e.g., visual representation 106) of the analysis protocol (e.g., analysis protocol 104) may take the form of an analysis flowchart or analysis diagram for the analysis protocol (e.g., analysis protocol 104). This visual tool (e.g., visual representation 106) outlines the steps involved in the analysis process (e.g., analysis protocol 104), including data collection, preprocessing, analysis methods, and interpretation of results. Each step in the visual representation (e.g., visual representation 106) is usually represented by a shape (e.g., a rectangle, a circle, or a diamond), with arrows indicating the flow of the analysis from one step to the next. This visual representation (e.g., visual representation 106) helps to clarify the sequence of tasks and dependencies in the analysis protocol (e.g., analysis protocol 104), making it easier to follow and understand.

As will be discussed below in greater detail, model explanation process 100 may associate 204 various portions of the analysis protocol (e.g., analysis protocol 104) with various portions of the visual representation (e.g., visual representation 106). Therefore, if the analysis protocol (e.g., analysis protocol 104) is a series of yes/no questions that are designed to diagnose a particular problem, model explanation process 100 may associate 204 various portions (e.g., the series of yes/no questions) of the analysis protocol (e.g., analysis protocol 104) with various portions (e.g., a series of question diamonds) of the visual representation (e.g., visual representation 106).

More generally and when associating 204 various portions of the analysis protocol (e.g., analysis protocol 104) with various portions of the visual representation (e.g., visual representation 106), model explanation process 100 may associate 206 various nodes/branches of the analysis protocol (e.g., analysis protocol 104) with various pixelated regions of the visual representation (e.g., visual representation 106).

In the context of a visual representation (e.g., visual representation 106) such as an analysis flowchart/diagram, nodes and branches are fundamental elements that help to structure and organize information.
Nodes: Nodes are the basic building blocks of a flowchart/diagram that represent individual steps, processes, or elements within a system. Each node typically contains a label or description to convey the meaning or purpose of that particular step or process. Nodes can take various shapes depending on the diagram's conventions (e.g., rectangles, circles, or diamonds).
Branches: Branches are the connections between nodes in a flowchart/diagram that represent the flow/progression of information from one step to another. Branches are usually depicted as lines or arrows linking the nodes (e.g., rectangles, circles, or diamonds) together and may illustrate the sequence of actions or decisions required to move from one stage of the process to the next.

Together, nodes and branches form a visual representation (e.g., visual representation 106) that conveys the structure, flow, and logic of a system, process, or analysis protocol (e.g., analysis protocol 104). They help to make complex information more understandable and accessible by breaking it down into smaller, more manageable components.

Model explanation process 100 may enable 208 a user (e.g., user 108) to utilize the generative AI system (e.g., generative AI system 102) during an interactive session (e.g., interactive session 110) concerning the analysis protocol (e.g., analysis protocol 104).

As discussed above, the analysis protocol (e.g., analysis protocol 104) may be a clinical diagnostic protocol in the healthcare space. Such protocols (e.g., analysis protocol 104) may be used by a clinician and may guide them through a series of questions to aid in the disease diagnosis for a patient. Other protocols (e.g., analysis protocol 104) may guide a patient through a series of questions so that information may be gathered from the patient to diagnose (or assist in diagnosing) a disease for the patient. Accordingly and in such a configuration, the user (e.g., user 106) of the generative AI system (e.g., generative AI system 102) may include a clinician and/or a patient.

In a medical environment, a clinician (also referred to as “healthcare provider” or “medical professional”) refers to a healthcare professional who is directly involved in patient care, diagnosis, treatment, and management. Clinicians include a wide range of professionals with different levels of training and specialties, such as physicians (including medical doctors and doctors of osteopathic medicine), nurses, physician assistants, nurse practitioners, and other allied health professionals like pharmacists, physical therapists, and occupational therapists.

Clinicians play a central role in providing comprehensive healthcare services to patients, often working collaboratively within interdisciplinary teams to address the diverse needs of patients. They are responsible for conducting patient assessments, making diagnoses, developing treatment plans, prescribing medications, performing procedures, and providing ongoing monitoring and follow-up care.

Model explanation process 100 may identify 210 an associated portion of the visual representation (e.g., visual representation 106) based, at least in part, upon a portion of the analysis protocol (e.g., analysis protocol 104) that is the current topic of the interactive session (e.g., interactive session 110).

For example, assume that the interactive session (e.g., interactive session 110) concerns an analysis protocol (e.g., analysis protocol 104) that is used to diagnose the severity of a patient's headaches so that a treatment plan may be defined. Accordingly, assume that the user (e.g., user 108) is the patient experiencing the headaches. Further, assume that the portion (e.g., portion 112) of the analysis protocol (e.g., analysis protocol 104) that is the current topic of the interactive session (e.g., interactive session 110) is the portion (e.g., portion 112) in which the analysis protocol (e.g., analysis protocol 104) inquiries about the quantity of headaches experienced by the user (e.g., user 108).

Accordingly, model explanation process 100 may identify 210 an associated portion (e.g., associated portion 114) of the visual representation (e.g., visual representation 106) based, at least in part, upon a portion (e.g., portion 112) of the analysis protocol (e.g., analysis protocol 104) that is the current topic (e.g., the quantity of headaches experienced by the user) of the interactive session (e.g., interactive session 110), wherein all or a portion of the visual representation (e.g., visual representation 106) may be rendered by model explanation process 100 for viewing by the user (e.g., user 108).

For example, assume that model explanation process 100 is effectuating the analysis protocol (e.g., analysis protocol 104) for the user (e.g., user 108) and the current topic of the interactive session (e.g., interactive session 110) is the quantity of headaches experienced by the user (e.g., user 108), namely portion 112 of analysis protocol 104. Accordingly, model explanation process 100 may generate an inquiry (e.g., “How many headache days do you have in an average week?”) for portion 112 of analysis protocol 104, wherein this inquiry may be provided to the user (e.g., user 108) in various forms (e.g., verbally or textually). As discussed above, model explanation process 100 identified 210 associated portion 114 of visual representation 106 as being associated with associated portion 112 of analysis protocol 104 since both portions concern the current topic (e.g., the quantity of headaches experienced by the user) of the interactive session (e.g., interactive session 110).

For example and when identifying 210 an associated portion (e.g., associated portion 114) of the visual representation (e.g., visual representation 106) based, at least in part, upon a portion (e.g., portion 112) of the analysis protocol (e.g., analysis protocol 104) that is the current topic (e.g., the quantity of headaches experienced by the user) of the interactive session (e.g., interactive session 110), model explanation process 100 may visually highlight 212 the associated portion (e.g., associated portion 114) of the visual representation (e.g., visual representation 106) based, at least in part, upon the portion (e.g., portion 112) of the analysis protocol (e.g., analysis protocol 104) that is the current topic (e.g., the quantity of headaches experienced by the user) of the interactive session (e.g., interactive session 110). Accordingly, model explanation process 100 may add visual highlighting 116 to associated portion 114 to visually highlight 212 associated portion 114 of visual representation 106 based, at least in part, upon portion 112 of analysis protocol 104 that is the current topic (e.g., the quantity of headaches experienced by the user) of interactive session 110.

Further and when identifying 210 an associated portion (e.g., associated portion 114) of the visual representation (e.g., visual representation 106) based, at least in part, upon a portion (e.g., portion 112) of the analysis protocol (e.g., analysis protocol 104) that is the current topic (e.g., the quantity of headaches experienced by the user) of the interactive session (e.g., interactive session 110), model explanation process 100 may explain 214 the associated portion (e.g., associated portion 114) of the visual representation (e.g., visual representation 106) based, at least in part, upon the portion (e.g., portion 112) of the analysis protocol (e.g., analysis protocol 104) that is the current topic (e.g., the quantity of headaches experienced by the user) of the interactive session (e.g., interactive session 110). Accordingly, model explanation process 100 may render explanation 118 to explain 214 the associated portion (e.g., associated portion 114) of the visual representation (e.g., visual representation 106) based, at least in part, upon the portion (e.g., portion 112) of the analysis protocol (e.g., analysis protocol 104) that is the current topic (e.g., the quantity of headaches experienced by the user) of the interactive session (e.g., interactive session 110).

Model explanation process 100 may monitor 216 a plurality of interactive sessions (e.g., plurality of interactive sessions 120) of the analysis protocol (e.g., analysis protocol 104) by a plurality of users (e.g., plurality of users 122), thus defining analysis protocol use data (e.g., analysis protocol use data 124). For example, model explanation process 100 may define analysis protocol use data 124 by monitoring 216 plurality of interactive sessions 120 of analysis protocol 104 for plurality of users 122 (which may be e.g., 100s of users, 1000s of users, tens of 1000s of users or millions of users),

Model explanation process 100 may generate 216 a heat map (e.g., heat map 126) based, at least in part, upon the analysis protocol use data (e.g., analysis protocol use data 124). In the context of a flowchart, a heatmap serves as a visual representation that illuminates the frequency or intensity of a specific aspect within the flowchart. Typically, this aspect pertains to metrics such as execution time, error occurrences, or resource usage throughout the process. The process begins with the collection of relevant data associated with the flowchart's performance. This data is then translated into a visual representation that overlays onto the flowchart itself. Through color-coding, elements within the flowchart are highlighted based on the collected data. For instance, elements experiencing high resource usage might be depicted in red, while those with low usage might be green. Users can then interpret the heatmap to discern patterns or areas of concern within the flowchart. This visualization aids in quickly understanding the performance or characteristics of the process, facilitating the identification of areas for improvement or optimization.

Accordingly and in this illustrative example, the heat map (e.g., heat map 126) may indicate a flow of the plurality of users (e.g., plurality of users 122) through the visual representation (e.g., visual representation 106) of the analysis protocol (e.g., analysis protocol 104). Accordingly and through the use of such a heat map (e.g., heat map 126), user flow may be analyzed and analysis protocol (e.g., analysis protocol 104) may be revised to address undesirable/unwanted flow patterns through the heat map (e.g., heat map 126).

### System Overview:

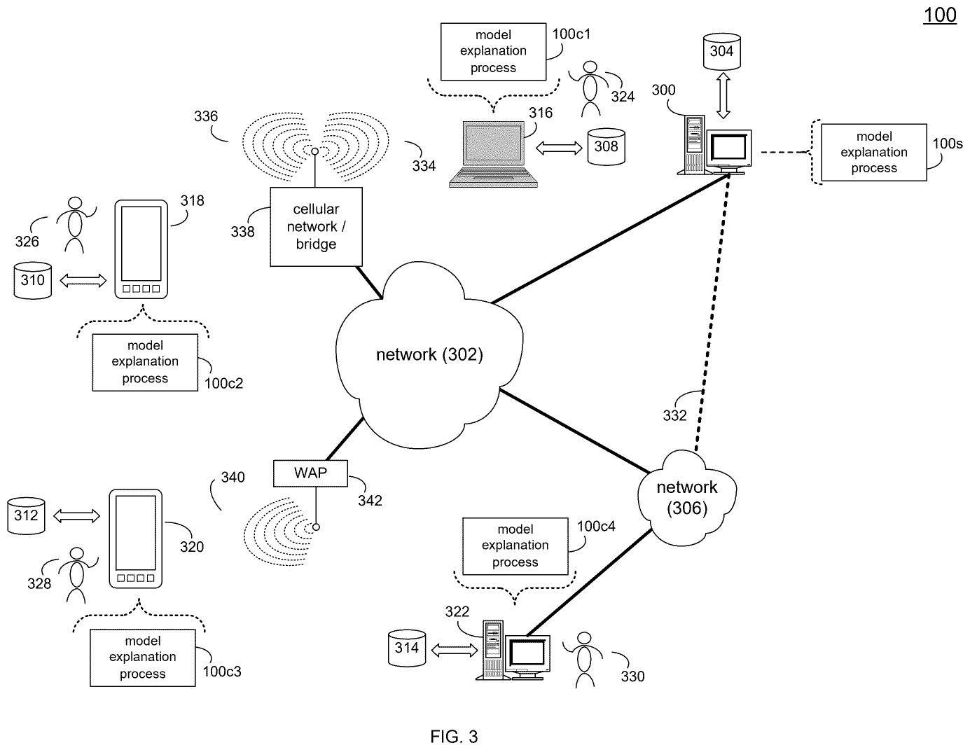

Referring to FIG. 3, there is shown model explanation process 100. Model explanation process 100 may be implemented as a server-side process, a client-side process, or a hybrid server-side/client-side process. For example, model explanation process 100 may be implemented as a purely server-side process via model explanation process 100s. Alternatively, model explanation process 100 may be implemented as a purely client-side process via one or more of model explanation process 100c1, model explanation process 100c2, model explanation process 100c3, and model explanation process 100c4. Alternatively still, model explanation process 100 may be implemented as a hybrid server-side/client-side process via model explanation process 100s in combination with one or more of model explanation process 100c1, model explanation process 100c2, model explanation process 100c3, and model explanation process 100c4.

Accordingly, model explanation process 100 as used in this disclosure may include any combination of model explanation process 100s, model explanation process 100c1, model explanation process 100c2, model explanation process 100c3, and model explanation process 100c4.

Model explanation process 100s may be a server application and may reside on and may be executed by computing device 300, which may be connected to network 302 (e.g., the Internet or a local area network). Examples of computing device 300 may include, but are not limited to: a personal computer, a server computer, a series of server computers, a mini computer, a mainframe computer, a smartphone, or a cloud-based computing platform.

The instruction sets and subroutines of model explanation process 100s, which may be stored on storage device 304 coupled to computing device 300, may be executed by one or more processors (not shown) and one or more memory architectures (not shown) included within computing device 300. Examples of storage device 304 may include but are not limited to: a hard disk drive; a RAID device; a random-access memory (RAM); a read-only memory (ROM); and all forms of flash memory storage devices.

Network 302 may be connected to one or more secondary networks (e.g., network 306), examples of which may include but are not limited to: a local area network; a wide area network; or an intranet, for example.

Examples of model explanation processes 300c1, 300c2, 300c3, 300c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of model explanation processes 300c1, 300c2, 300c3, 300c4, which may be stored on storage devices 308, 310, 312, 314 (respectively) coupled to client electronic devices 316, 318, 320, 322 (respectively), may be executed by one or more processors (not shown) and one or more memory architectures (not shown) incorporated into client electronic devices 316, 318, 320, 322 (respectively). Examples of storage devices 308, 310, 312, 314 may include but are not limited to: hard disk drives; RAID devices; random access memories (RAM); read-only memories (ROM), and all forms of flash memory storage devices.

Examples of client electronic devices 316, 318, 320, 322 may include, but are not limited to a personal digital assistant (not shown), a tablet computer (not shown), laptop computer 316, smart phone 318, smart phone 320, personal computer 322, a notebook computer (not shown), a server computer (not shown), a gaming console (not shown), and a dedicated network device (not shown). Client electronic devices 316, 318, 320, 322 may each execute an operating system, examples of which may include but are not limited to Microsoft Windows™, Android™, iOS™, Linux™, or a custom operating system.

Users 324, 326, 328, 330 may access model explanation process 10 directly through network 302 or through secondary network 306. Further, model explanation process 10 may be connected to network 302 through secondary network 306, as illustrated with link line 332.

The various client electronic devices (e.g., client electronic devices 316, 318, 320, 322) may be directly or indirectly coupled to network 302 (or network 306). For example, laptop computer 316 and smart phone 318 are shown wirelessly coupled to network 302 via wireless communication channels 334, 336 (respectively) established between laptop computer 316, smart phone 318 (respectively) and cellular network/bridge 338, which is shown directly coupled to network 302.

Further, smart phone 320 is shown wirelessly coupled to network 302 via wireless communication channel 340 established between smart phone 320 and wireless access point (i.e., WAP) 342, which is shown directly coupled to network 302. Additionally, personal computer 322 is shown directly coupled to network 306 via a hardwired network connection.

WAP 342 may be, for example, an IEEE 802.11a, 802.11b, 802.11g, 802.11n, Wi-Fi, and/or Bluetooth device that is capable of establishing wireless communication channel 340 between smart phone 320 and WAP 342. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
enabling a generative AI system to effectuate an analysis protocol;
defining a visual representation of the analysis protocol;
associating various portions of the analysis protocol with various portions of the visual representation;
enabling a user to utilize the generative AI system during an interactive session concerning the analysis protocol; and
identifying an associated portion of the visual representation based, at least in part, upon a portion of the analysis protocol that is the current topic of the interactive session.

2. The computer-implemented method of claim 1 wherein associating various portions of the analysis protocol with various portions of the visual representation includes:
associating various nodes/branches of the analysis protocol with various pixelated regions of the visual representation.

3. The computer-implemented method of claim 1 wherein the visual representation of the analysis protocol includes an analysis flowchart for the analysis protocol.

4. The computer-implemented method of claim 1 wherein identifying an associated portion of the visual representation based, at least in part, upon a portion of the analysis protocol that is the current topic of the interactive session includes:
visually highlighting the associated portion of the visual representation based, at least in part, upon the portion of the analysis protocol that is the current topic of the interactive session.

5. The computer-implemented method of claim 1 wherein identifying an associated portion of the visual representation based, at least in part, upon a portion of the analysis protocol that is the current topic of the interactive session includes:
explaining the associated portion of the visual representation based, at least in part, upon the portion of the analysis protocol that is the current topic of the interactive session.

6. The computer-implemented method of claim 1 further comprising:
monitoring a plurality of interactive sessions of the analysis protocol by a plurality of users, thus defining analysis protocol use data.

7. The computer-implemented method of claim 6 further comprising:
generating a heat map based, at least in part, upon the analysis protocol use data.

8. The computer-implemented method of claim 7 wherein the heat map indicates a flow of the plurality of users through the visual representation of the analysis protocol.

9. The computer-implemented method of claim 1 wherein the user includes one or more of a clinician and a patient.

10. The computer-implemented method of claim 1 wherein in the analysis protocol is a clinical diagnostic protocol.

11. A computer program product residing on a computer readable medium having a plurality of instructions stored thereon which, when executed by a processor, cause the processor to perform operations comprising:
enabling a generative AI system to effectuate an analysis protocol;
defining a visual representation of the analysis protocol;
associating various portions of the analysis protocol with various portions of the visual representation;
enabling a user to utilize the generative AI system during an interactive session concerning the analysis protocol; and
identifying an associated portion of the visual representation based, at least in part, upon a portion of the analysis protocol that is the current topic of the interactive session;
wherein associating various portions of the analysis protocol with various portions of the visual representation includes:
associating various nodes/branches of the analysis protocol with various pixelated regions of the visual representation.

12. The computer-implemented method of claim 11 wherein the visual representation of the analysis protocol includes an analysis flowchart for the analysis protocol.

13. The computer-implemented method of claim 11 wherein identifying an associated portion of the visual representation based, at least in part, upon a portion of the analysis protocol that is the current topic of the interactive session includes:
visually highlighting the associated portion of the visual representation based, at least in part, upon the portion of the analysis protocol that is the current topic of the interactive session.

14. The computer-implemented method of claim 11 wherein identifying an associated portion of the visual representation based, at least in part, upon a portion of the analysis protocol that is the current topic of the interactive session includes:
explaining the associated portion of the visual representation based, at least in part, upon the portion of the analysis protocol that is the current topic of the interactive session.

15. The computer-implemented method of claim 11 wherein the user includes one or more of a clinician and a patient.

16. The computer-implemented method of claim 11 wherein in the analysis protocol is a clinical diagnostic protocol.

17. A computing system including a processor and memory configured to perform operations comprising:
enabling a generative AI system to effectuate an analysis protocol;
defining a visual representation of the analysis protocol;
associating various portions of the analysis protocol with various portions of the visual representation;
enabling a user to utilize the generative AI system during an interactive session concerning the analysis protocol; and
identifying an associated portion of the visual representation based, at least in part, upon a portion of the analysis protocol that is the current topic of the interactive session;
monitoring a plurality of interactive sessions of the analysis protocol by a plurality of users, thus defining analysis protocol use data; and
generating a heat map based, at least in part, upon the analysis protocol use data.

18. The computer-implemented method of claim 17 wherein the visual representation of the analysis protocol includes an analysis flowchart for the analysis protocol.

19. The computer-implemented method of claim 17 wherein identifying an associated portion of the visual representation based, at least in part, upon a portion of the analysis protocol that is the current topic of the interactive session includes:
visually highlighting the associated portion of the visual representation based, at least in part, upon the portion of the analysis protocol that is the current topic of the interactive session.

20. The computer-implemented method of claim 17 wherein identifying an associated portion of the visual representation based, at least in part, upon a portion of the analysis protocol that is the current topic of the interactive session includes:
explaining the associated portion of the visual representation based, at least in part, upon the portion of the analysis protocol that is the current topic of the interactive session.
